(19) United States
(12) Patent Application Publication
(10) Pub. No.: US 2012/0050743 A1
(43) Pub. Date: Mar. 1, 2012

(54) Apparatus of absorption spectroscopy for gaseous samples

(75) Inventors: Kenichi Yanai, Nisshin-city (JP); Iwao Hosako, Koganei-city (JP); Junichi Hamazaki, Koganei-city (JP)

(73) Assignees: National Institute of Information and Communications Technology, Tokyo (JP); DENSO CORPORATION, Kariya-city (JP)

(21) Appl. No.: 13/199,502

(22) Filed: Aug. 31, 2011

(30) Foreign Application Priority Data
Sep. 1, 2010 (JP) 2010-195725

(51) Int. Cl. G01N 21/49

(52) U.S. Cl. 356/437

(57) ABSTRACT

An absorption spectroscopy apparatus provides an apparatus for analyzing gaseous sample. A measuring section irradiates the gaseous sample with terahertz radiation. An analysis section calculates a concentration of a specific constituent based on a level of absorbance by the gaseous sample. Terahertz radiation at least contains frequency components where the specific constituent shows an absorbance larger than an absorbance by a background constituent. Terahertz radiation at least contains frequency components where a spectrum of absorbance by the background constituent shows relatively flat profile.

### CROSS REFERENCE TO RELATED APPLICATION

This application is based on Japanese Patent Application No. 2010-195725 filed on Sep. 1, 2010, the contents of which are incorporated herein by reference in its entirety.

### FIELD OF THE INVENTION

The present invention relates to an apparatus of absorption spectroscopy for measuring a concentration of a specific constituent in gaseous samples, such as an alcohol concentration in a gaseous sample.

### BACKGROUND OF THE INVENTION

In order to measure a level of the influence of alcohol, some vehicle mountable apparatuses for detecting such an influence level of a driver are proposed. For example, JP2009-92450A discloses one. In this apparatus, a concentration of ethanol is measured by using an infrared light which has wavelength corresponding to an absorbance that is peculiar to ethanol.

According to the apparatus in JP2009-92450A, it is necessary to irradiate a sample with infrared light which has wavelength that corresponds to an absorbance peculiar to ethanol. A range of frequency band of absorbance wavelength is narrow. Therefore, the frequency resolution of the component which irradiates infrared light must be high, and as a result, the apparatus for detecting an influence level must be expensive.

### SUMMARY OF THE INVENTION

It is an object of the present invention to provide an apparatus of spectroscopy with low cost, which is capable of measuring a concentration of specific constituent. It is another object of the present invention to provide an apparatus of spectroscopy for measuring a concentration of specific constituent, such as ethanol, in gaseous samples.

The absorption spectroscopy apparatus of the present invention calculates a concentration of a specific constituent based on a level of absorbance of terahertz radiation by the specific constituent. Absorbance of terahertz radiation by the specific constituent is distributed over a broad frequency range in compared with other radiation. Therefore, the apparatus of absorption spectroscopy for gaseous samples is not required to have means of irradiating terahertz radiation with high resolution of frequency discrimination. As a result, it is possible to reduce manufacturing cost of the absorption spectroscopy apparatus. In the absorption spectroscopy apparatus of the present invention, the specific constituent can be measured with sufficient accuracy.

It is preferable that the terahertz radiation used in the measuring section may contain a range of frequency where the specific constituent shows an absorbance that is larger than an absorbance by a background constituent contained in the gaseous sample, and where a spectrum of absorbance by the background constituent shows relatively flat profile. By this, it is possible to reduce influence by the background constituent, and to measure a concentration of the specific constituent with sufficient accuracy.

The apparatus of absorption spectroscopy for gaseous samples may include background absorption spectral acquiring means for acquiring a spectral of the absorbance of the background constituent in a range of terahertz. The apparatus of absorption spectroscopy for gaseous samples may further include frequency setting means for setting a frequency of terahertz radiation used in the measuring section based on the spectral of absorbance by the background constituent. By this, it is possible to set a frequency that shows small influence of absorption by the background constituent according to the background constituent at the time of measurement as a frequency used in measuring and evaluating process.

It is preferable that a width in frequency of terahertz radiation used in a calculating of a concentration of the specific constituent is equal to or lower than ±3 cm⁻¹. By this, since an S/N ratio can be improved, it is possible to improve measuring accuracy of the specific constituent further. S/N ratio or SN is a ratio of a detection value of the specific constituent and a detection value of the background constituent.

In the apparatus of absorption spectroscopy for gaseous samples, the measuring section may be arranged to acquire absorbance in a plurality of frequencies, respectively. In addition, the analysis section may be arranged to identify the kind of the specific constituent based on a pattern of absorbance in the plurality of frequencies. By this, not only a concentration measurement of the specific constituent, but also an identification of the kind of arbitrary gas constituent and a concentration measurement can be performed. This feature is based on that a level and/or profile of absorbance on a plurality of frequencies are peculiar to the specific constituent.

Wide variety of substances that shows broad absorption characteristic in a frequency range of the terahertz radiation can be used as the specific constituent. For example, the specific constituent may be component of alcohol, e.g., methanol, ethanol, and propanol, or water.

Terahertz radiation is electromagnetic radiation which have a frequency of from 0.1 THz to 10 THz. Terahertz radiation used in the present invention may include one frequency range, and may include a combination of a plurality of frequency ranges.

The background constituent means constituents other than the specific constituent which serves as a measuring object among the constituents of a gaseous sample. For example, the background constituent corresponds to the constituent of the general atmosphere, i.e., a mixture of nitrogen, oxygen, and minor constituents (e.g., steam, carbon dioxide, argon, etc.) other than the specific constituent.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a block diagram showing an apparatus of absorption spectroscopy for gaseous samples according to an embodiment of the present invention;

FIG. 2 is a graph showing a waveform of electric field strength of terahertz radiation;

FIG. 3 is a graph showing an intensity of transmitted light which transmitted through a background atmosphere;

FIG. 4 is a graph showing a waveform of electric field strength of a terahertz radiation;

FIG. 5 is a graph showing an intensity of transmitted light which transmitted through a gaseous sample;

FIG. 6 is a graph showing a level of absorbance by a background atmosphere and a level of absorbance by a gaseous sample in frequency components;

FIG. 7 is a graph showing frequency components which is hard to be absorbed by the background atmosphere;

FIG. 8 is a graph showing a level of absorbance by ethanol with respect to frequency components;

FIG. 9 is a graph showing relations between an ethanol concentration (partial pressure) and an absorbance by ethanol for a gaseous sample S1 and a gaseous sample S2;

FIG. 10 is a graph showing levels of absorbance by the atmosphere, ethanol, and a mixture of both which is a gaseous sample S1;

FIG. 11 is an enlarged view of a part of FIG. 10;

FIG. 12 is a graph showing distribution of SN (Signal/Noise) value, which is obtained by experimental works in which width of frequency in integrating process of absorbance, and the center value of frequency are varied;

FIG. 13 is a block diagram showing an apparatus of absorption spectroscopy for gaseous samples according to a second embodiment of the present invention; and

FIG. 14 is a graph showing levels of absorbance of some substances in the frequency range of terahertz radiation.

### DETAILED DESCRIPTION OF THE PREFERRED EMBODIMENTS

Hereinafter embodiments of the present invention are described in detail.

### First Embodiment

(1) System

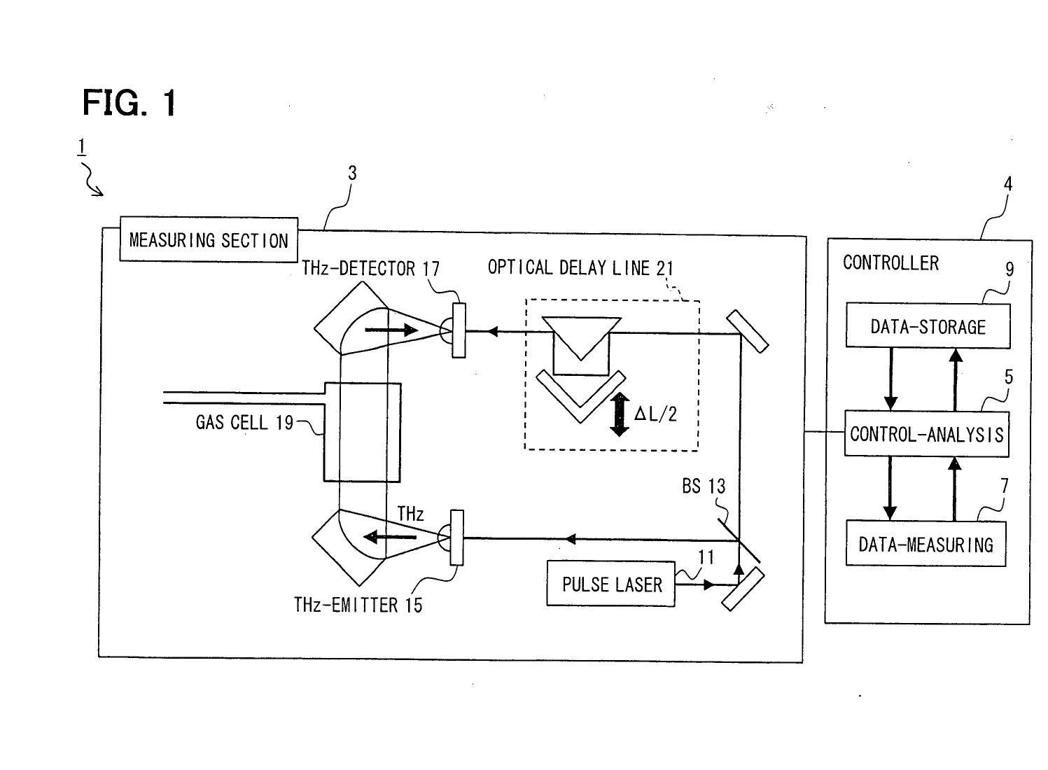

System of an absorption spectroscopy apparatus 1 according to the first embodiment is described while referring to FIG. 1. An absorption spectroscopy apparatus 1 may be referred to as a gaseous sample analyzing apparatus which is an apparatus for measuring a concentration of alcohol in breath of a driver of a vehicle. An absorption spectroscopy apparatus 1 may be an in-vehicle apparatus.

An absorption spectroscopy apparatus 1 includes a measuring section 3 and a controller 4. The controller 4 includes a control-analysis section 5, a data-measuring section 7, and a data-storage section 9. The measuring section 3 is a measurement part that has components and structure known as the time-domain spectroscopy (TDS) system. The measuring section 3 includes a pulse laser 11, a beam splitter (BS) 13, a THz emitter 15, a THz detector 17, a gas cell 19, and an optical delay line 21. The pulse laser 11 is used to generate and detect terahertz radiation having a frequency within a terahertz region. Terahertz radiation is electromagnetic radiation which has a frequency of from 0.1 THz to 10 THz. Pulse laser from the pulse laser 11 is splitted by the beam splitter 13 and directed to the THz emitter 15 and the THz detector 17. The gas cell 19 holds a gaseous sample to be analyzed. The optical delay line 21 causes a time delay on one of signals from by the beam splitter 13.

A part of pulse beam generated by the pulse laser 11 is reflected on and splitted by the beam splitter 13. Then, the reflected part of pulse beam enters into the THz emitter 15, and is used to generate and radiate a terahertz radiation pulse. The terahertz radiation pulse transmits through the gas cell 19, and reaches to the THz detector 17. On the other hand, the other part of pulse beam generated by the pulse laser 11 transmits through the beam splitter 13. The transmitted part of pulse beam passes through the optical delay line 21, and then, reaches to the THz detector 17, and is used to measure delay time shown by waveforms of THz radiation waves. Terahertz radiation used in the measuring section 3 at least contains a range of frequency which at least includes a plurality of frequency components. Terahertz radiation at least contains a frequency range where the specific constituent shows an absorbance that is larger than an absorbance by a background constituent. The background constituent is contained in the gaseous sample as an unavoidable constituent. The terahertz radiation at least contains a frequency range where a spectrum of absorbance by the background constituent shows relatively flat profile.

The control-analysis section 5 controls the optical delay line 21, and receives measured data from the data-measuring section 7. The control-analysis section 5 acquires measured data from the data-measuring section 7 according to the control signal for controlling the optical delay line 21. The control-analysis section 5 may includes a well-known CPU, and performs a plurality of processing mentioned later.

The data-measuring section 7 is installed close to the measuring section 3. The data-measuring section 7 acquires measured data from the THz detector 17 in response to a command signal from the control-analysis section 5. The data-storage section 9 cooperates with the control-analysis section 5, and stores measured data. The data-storage section 9 also stores data for a database mentioned later.

(2) Processing

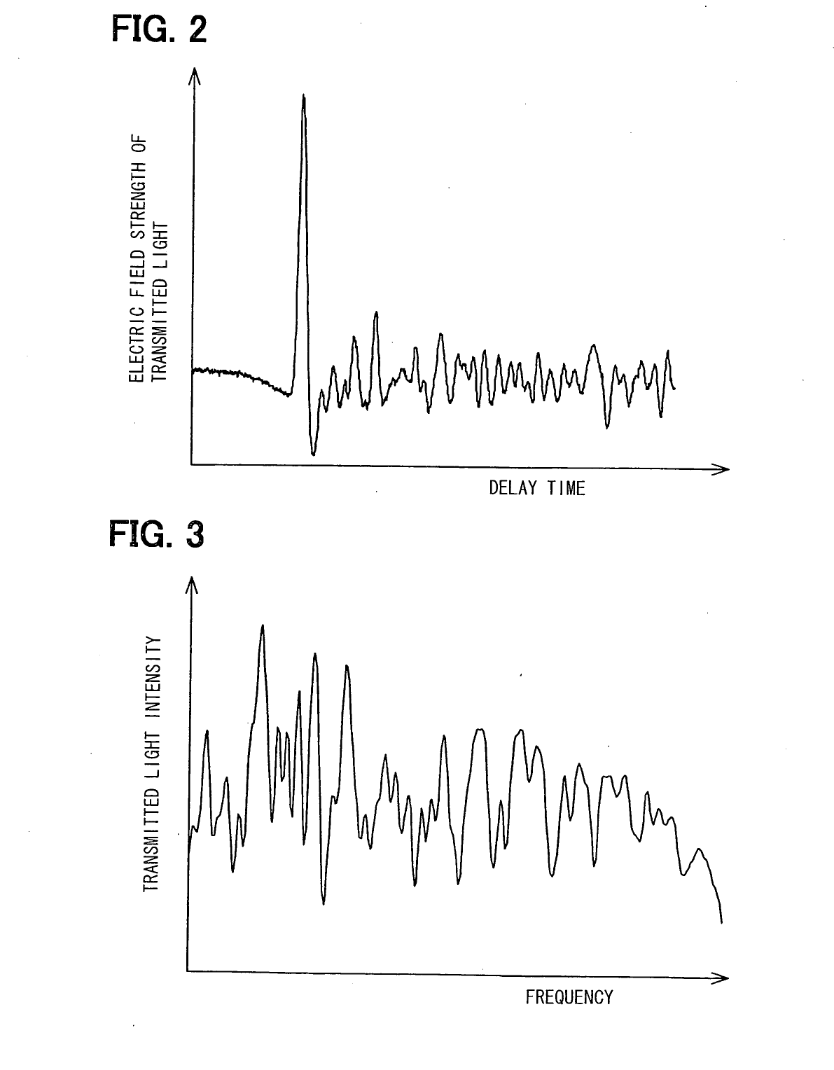

Processing of the absorption spectroscopy apparatus 1 is described while referring to FIGS. 2-8.

(i) Measurement of Background

The apparatus 1 provides a background measuring module which measures an intensity of transmitted terahertz radiation transmitted through the atmosphere, which contains no ethanol or ethanol lower than detection limit. The background atmosphere may be called as an air only contains background constituents. In the background measuring module, the gas cell 19 is filled with the background atmosphere. Then, the optical delay line 21 is activated and operated to vary delay time. While operating the optical delay line, electric field strength of transmitted light is measured. Electric field strength indicates strength of an electric field that is generated by the THz emitter 15, is passed through the gas cell 19, and is detected by the THz detector 17. As a result, a waveform of electric field strength of terahertz radiation is obtained. FIG. 2 shows an example of a waveform of electric field strength of terahertz radiation. The waveform of electric field strength of terahertz radiation is stored in the data-storage section 9 as measured data.

The background atmosphere may be introduced into the gas cell 19 in an automatic manner by not illustrated introducing mechanism. Alternatively, the background atmosphere may be introduced via a manually operated mechanism. Next, the waveform of electric field strength of terahertz radiation is processed by Fourier transformation. As a result, levels of electric field strength transmitted through the background atmosphere in each one of frequency components are obtained. The levels of electric field strength may be called as intensity of transmitted light. FIG. 3 shows the result of Fourier transformation.

(ii) Measurement of Sample

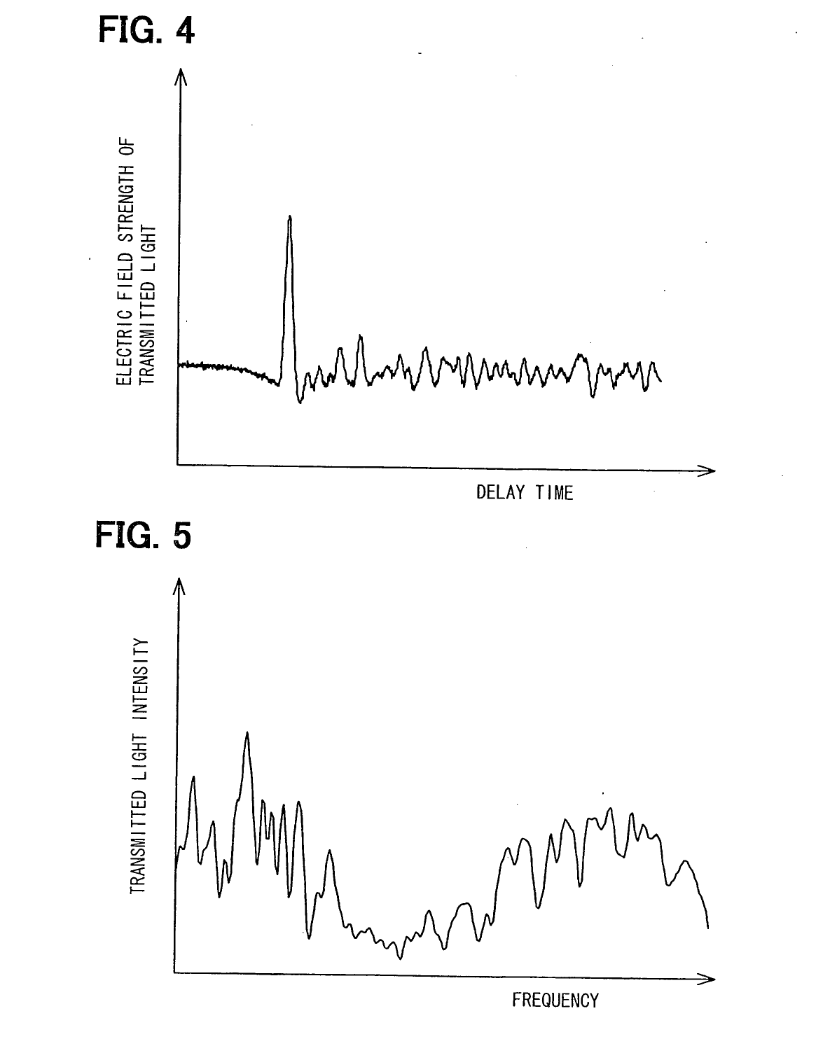

The apparatus 1 provides a sample measuring module which measures an intensity of transmitted terahertz radiation transmitted through a gaseous sample, which may contain ethanol. In the sample measuring module, the gas cell 19 is filled with the gaseous sample which contains ethanol as a specific constituent. Then, the optical delay line 21 is activated and operated to vary delay time. While operating the optical delay line, electric field strength of transmitted light is measured. The electric field strength indicates strength of electric field that is generated by the THz emitter 15, is passed through the gas cell 19, and is detected by the THz detector 17. As a result, a waveform of electric field strength of terahertz radiation is obtained. FIG. 4 shows an example of a waveform of electric field strength of terahertz radiation. The waveform of electric field strength of terahertz radiation is stored in the data-storage section 9 as measured data.

The gaseous sample may be introduced into the gas cell 19 in an automatic manner by not illustrated introducing mechanism. Next, the waveform of electric field strength of terahertz radiation transmitted through the gaseous sample is processed by Fourier transformation. FIG. 5 shows the result of Fourier transformation.

(iii) Calculation of Absorbance

The apparatus 1 provides a calculating module which calculates levels of the absorbance in respective frequency components. The calculating module may include a first calculating module which calculates the absorbance by the background atmosphere. The calculating module may include a second calculating module which calculates the absorbance by the gaseous sample.

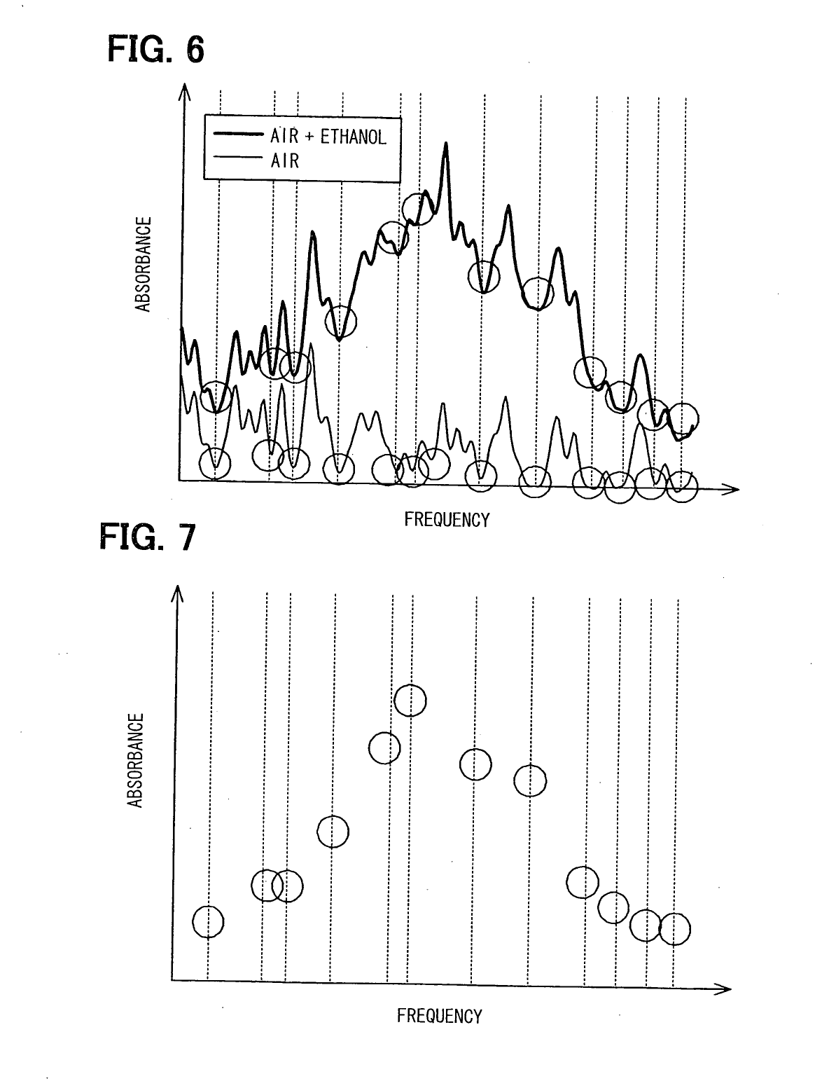

The first calculating module calculates levels of absorbance in each one of frequency components based on the levels of electric field strength of the background atmosphere obtained by the processing (i). The second calculating module calculates levels of the absorbance in each one of frequency components based on the levels of the electric field strength of the gaseous sample obtained by the processing (ii). FIG. 6 shows an example result of processing of the calculating module. The background atmosphere is a background constituent in the gaseous sample. The processing for calculating the levels of absorbance of the background atmosphere in frequency components may correspond to a background absorption spectral acquiring means for acquiring a spectral of the absorbance which is shown by the background constituent contained in the gaseous sample with respect to a range of terahertz.

(iv) Selection of Frequency

The apparatus 1 provides a frequency selecting module which selects one or a plurality of frequencies that shows relatively low level of absorbance by the background atmosphere compared with the surrounding frequencies. In the frequency selecting module, a plurality of frequencies that shows relatively low level of absorbance by the background atmosphere is selected based on the levels of absorbance in respective frequencies obtained by the processing (iii). In the example shown in FIG. 6, the frequencies marked with circular symbols are selected. FIG. 7 shows selected frequencies. This processing corresponds to a frequency setting means for setting at least one frequency of terahertz radiation used in the control-analysis section 5 based on the spectral of absorbance by the background constituent.

(v) Exclusion of Influence

The apparatus 1 provides an exclusion module which excludes influence caused by the background atmosphere. The exclusion module may include band pass filtering means which performs a band pass filtering process by excluding components outside a frequency band defined on the frequency selected in the frequency setting means. The band pass filtering means filters both the levels of absorbance by the background constituent and the levels of absorbance by the specific constituent. The exclusion module may include an integrating means for integrating the levels of absorbance filtered by the band pass filtering means. The exclusion module may include a background excluding means for excluding components caused by an influence of the background constituent in the levels of absorbance of the gaseous sample. The background excluding means excludes influence caused by the background constituent by subtracting the levels of absorbance by the background constituent from the levels of absorbance by the gaseous sample. Therefore, the exclusion module includes means for band pass filtering and means for canceling influence of the background constituent. In the exclusion module, at least one level of absorption within a frequency band is calculated based on the level of absorption of the gaseous sample calculated in the processing (iii).

Since a plurality of levels of absorbance by the gaseous sample in respective frequency components are calculated in the processing (iii), a plurality of levels of absorbance within the frequency band is calculated in this embodiment. The frequency band is defined based on the frequency selected and set in the processing (iv). The frequency band is defined by a center value that is the frequency selected and set in the processing (iv), and a band width predetermined before hand. The frequency band of terahertz radiation used in the calculation of the concentration of the specific constituent is equal to or less than ±3 cm⁻¹. The exclusion module integrates or accumulates levels of absorption within the frequency band in order to detect effective components that are responsive to the specific constituent. In other words, the exclusion module excludes components outside the frequency band. Since the exclusion module integrates levels of absorption within the frequency band, hereinafter the integrated value of absorption is called as a level α (ALPHA) of absorption. Since a plurality of frequencies are set in the processing (iv), a plurality of levels α (ALPHA) are calculated for every frequencies.

In the exclusion module, at least one level of absorption within a frequency band is calculated based on the level of absorption of the background atmosphere calculated in the processing (iii). Since a plurality of levels of absorption by the background atmosphere in respective frequency components are calculated in the processing (iii), a plurality of levels of absorption within the frequency bands are calculated in this embodiment. The frequency band is defined based on the frequency selected and set in the processing (iv). The frequency band is defined by a center value that is the frequency selected and set in the processing (iv), and a band width predetermined before hand. The frequency band is equal to or less than ±3 cm⁻¹. The exclusion module integrates or accumulates levels of absorption within the frequency band in order to detect effective components that are responsive to the background atmosphere. In other words, the exclusion module excludes components outside the frequency band. Since the exclusion module integrates levels of absorption within the frequency band, hereinafter the integrated value of absorption is called as a level β (BETA) of absorption. Since a plurality of frequencies are set in the processing (iv), a plurality of levels β (BETA) are calculated for every frequencies.

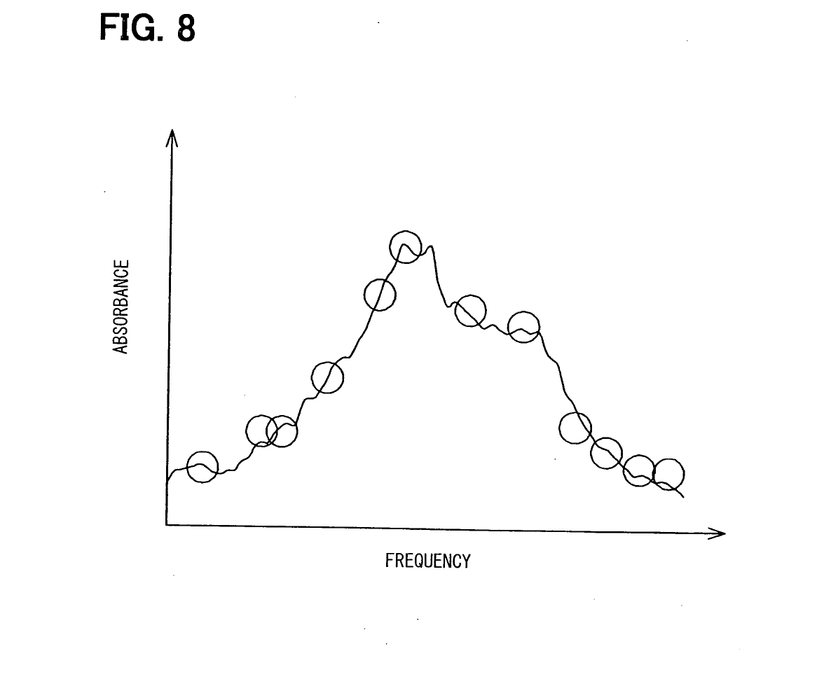

Then, in each one of selected frequencies, a level γ (GAMMA) is calculated by subtracting the level β (BETA) of absorbance from the level α (ALPHA) of absorbance. The level γ (GAMMA) shows a difference between the level α (ALPHA) and the level β (BETA). The level γ (GAMMA) corresponds to an absorbance obtained only by ethanol in the selected frequency. FIG. 8 shows the level γ (GAMMA) of absorbance by circular symbols.

(vi) Calculation of Ethanol Concentration

The apparatus 1 provides a calculation module which calculates a concentration of target constituent, i.e., ethanol. The data storage section 9 stores a database that defines a concordance between the absorbance γ (GAMMA) of ethanol in each one of frequencies and a concentration of ethanol in a sample. The calculation module calculates an ethanol concentration corresponding to the absorbance γ (GAMMA) of ethanol calculated in the processing (v) in the frequency set up by the processing (iv) based on the database. The calculation module searches the database based on the absorbance γ (GAMMA) of ethanol calculated in the processing (v) in the frequency set up by the processing (iv), and reads out corresponding data of a concentration from the database.

Broad absorption characteristic, i.e., a pattern of absorption, in the terahertz range is peculiar to a substance. For this reason, if a second specific constituent that is other than ethanol is mixed in a sample, it is possible to identify the kind of the second specific constituent mixed and is possible to estimate a concentration of the second constituent in a mathematical manner. The kind and a concentration of the second constituent may be estimated by mathematically giving a solution that simultaneously satisfies both the levels of absorbance in the plurality of frequency points and the absorption characteristics of known substances.

(3) Advantages

The absorption spectroscopy apparatus 1 calculates an ethanol concentration by using frequency components that shows relatively low absorbance by the background atmosphere in the frequency range of terahertz which is radiated from the THz emitter.

Since the frequency of absorption spectrum of ethanol is distributed comparatively broadly, the absorption spectroscopy apparatus 1 may be not required to have high frequency discrimination resolution. Frequency discrimination resolution is defined by a moving width of the optical delay line 21. For example, in order to satisfy a frequency discrimination resolution of 4 cm⁻¹ (120 GHz), 0.5 cm⁻¹ (15 GHz), and 0.1 cm⁻¹ (3 GHz), the optical delay line 21 is required to provide a moving width of about 0.125 cm, about 1 cm, and about 5 cm, respectively. In the absorption spectroscopy apparatus 1, as mentioned above, since the frequency discrimination resolution of terahertz radiation can be low resolution, it is possible to narrow the moving width of the optical delay line 21. As a result, it is possible to make the optical delay line 21 and the absorption spectroscopy apparatus 1 small. As a result, it is possible to reduce manufacturing cost of the absorption spectroscopy apparatus 1. In addition, it is possible to shorten measuring time by making the moving width in narrow.

(4) Evaluation of Accuracy

In order to evaluate accuracy of the absorption spectroscopy apparatus 1, a gaseous sample S1 which is a mixture of air and ethanol of known various concentration, and a gaseous sample S2 which consists only ethanol of known various concentration are prepared.

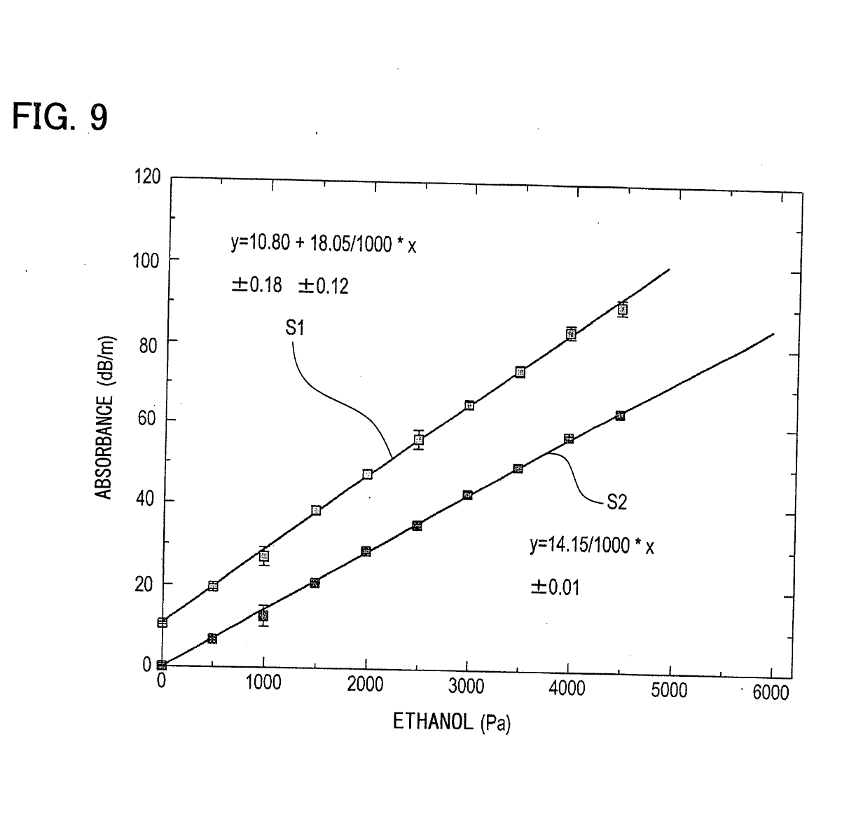

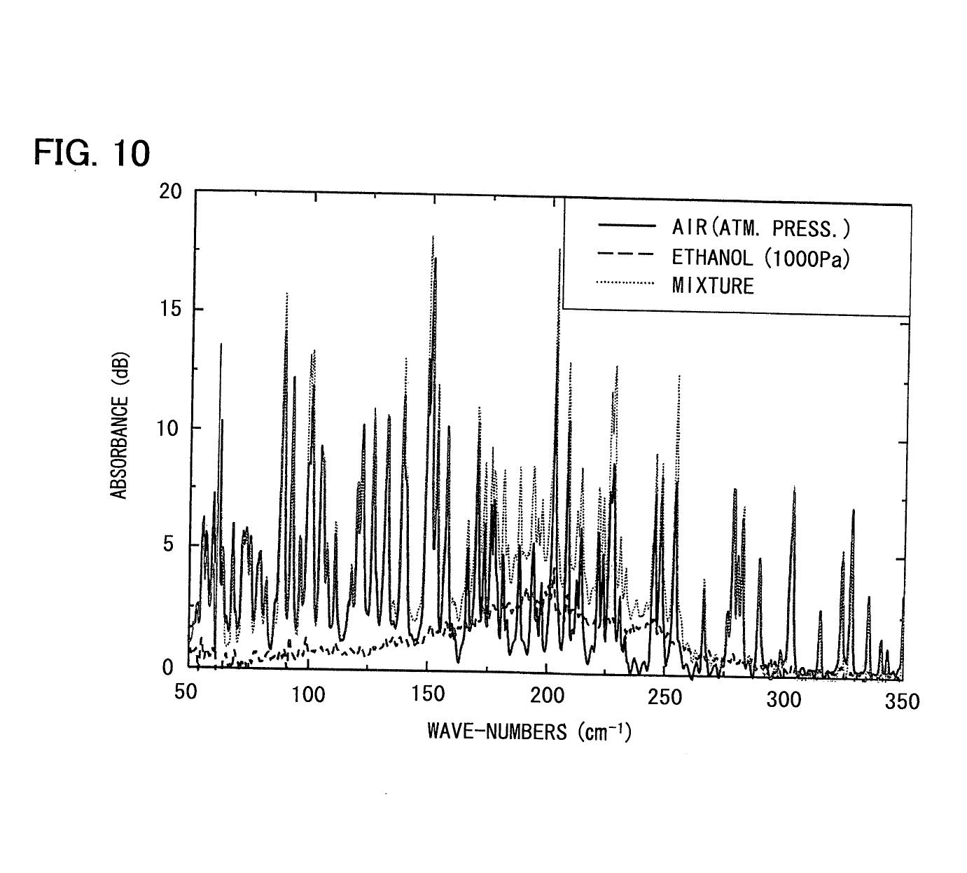

In the evaluation, levels α (ALPHA) of absorbance by ethanol are measured for the gaseous samples S1 and S2 by using a method including steps explained in the above-mentioned processing (3)(i)-(v). FIG. 9 is a graph showing relations between the known ethanol concentration (partial pressure) and a calculated level α (ALPHA) of absorbance by ethanol for the gaseous sample S1 and the gaseous sample S2. As it is apparent from FIG. 9, the absorbance level a (ALPHA) by ethanol is correlated with ethanol concentration very well. Therefore, it may be concluded that the concentration of ethanol can be calculated with sufficient accuracy from the absorbance by ethanol obtained by the embodiment.

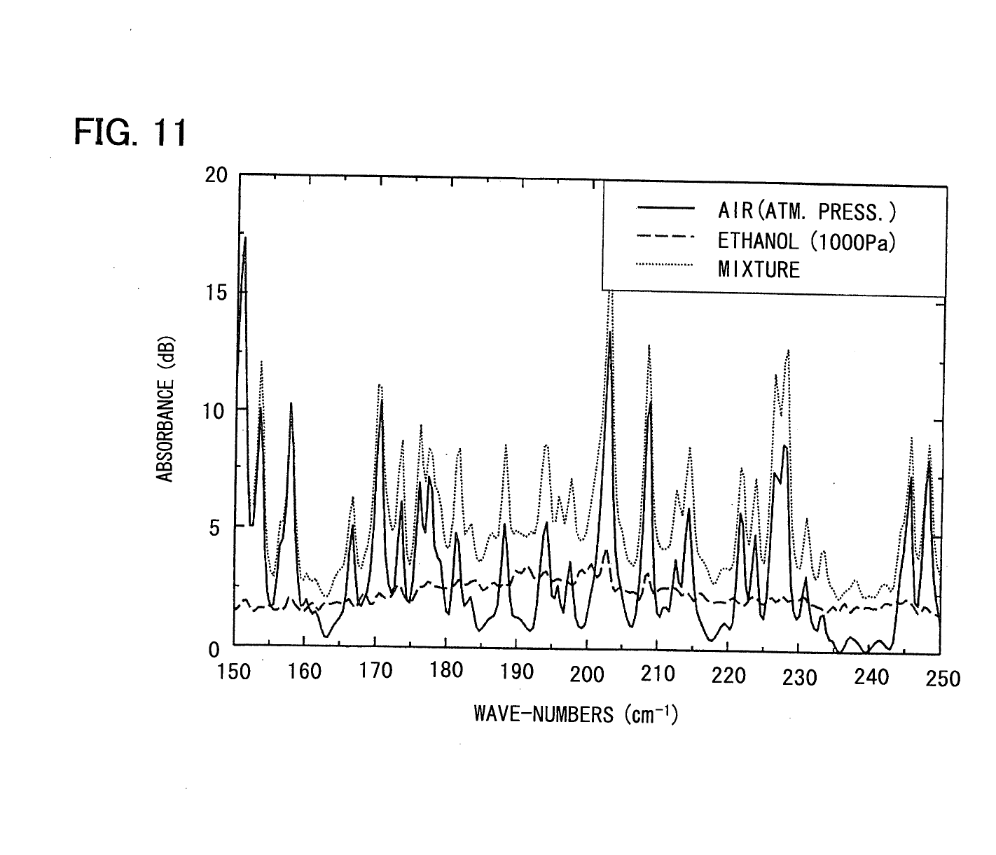

FIG. 10 and FIG. 11 show levels of absorbance of the atmosphere, ethanol (the gaseous sample S2), and a mixture of both (the gaseous sample S1).

(5) Discussion about Frequency Width

In the above-mentioned processing (2)(v), the frequency width is set ±3 cm⁻¹. In order to inspect an appropriateness of frequency width used in the processing (2)(v), absorbance by ethanol and absorbance by the background atmosphere are calculated while changing frequency width and center frequency for measuring.

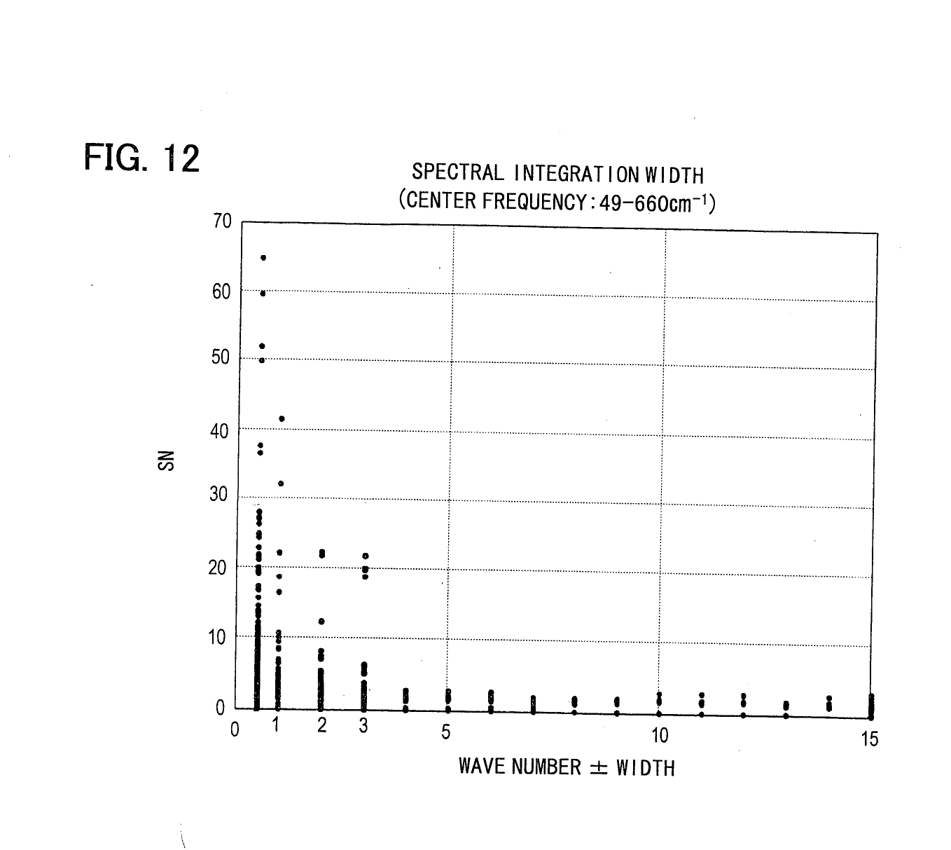

In this inspection, a signal-noise ratio SN is obtained by dividing an absorbance of ethanol by an absorbance of the background atmosphere. FIG. 12 shows a correlation between frequency width and SN. As shown in FIG. 12, SN may be equal to or larger than 20, when frequency width equal to or lower than ±3 cm⁻¹. Therefore, it seems preferable that frequency width is equal to or narrower than ±3 cm⁻¹.

### Second Embodiment

(1) System

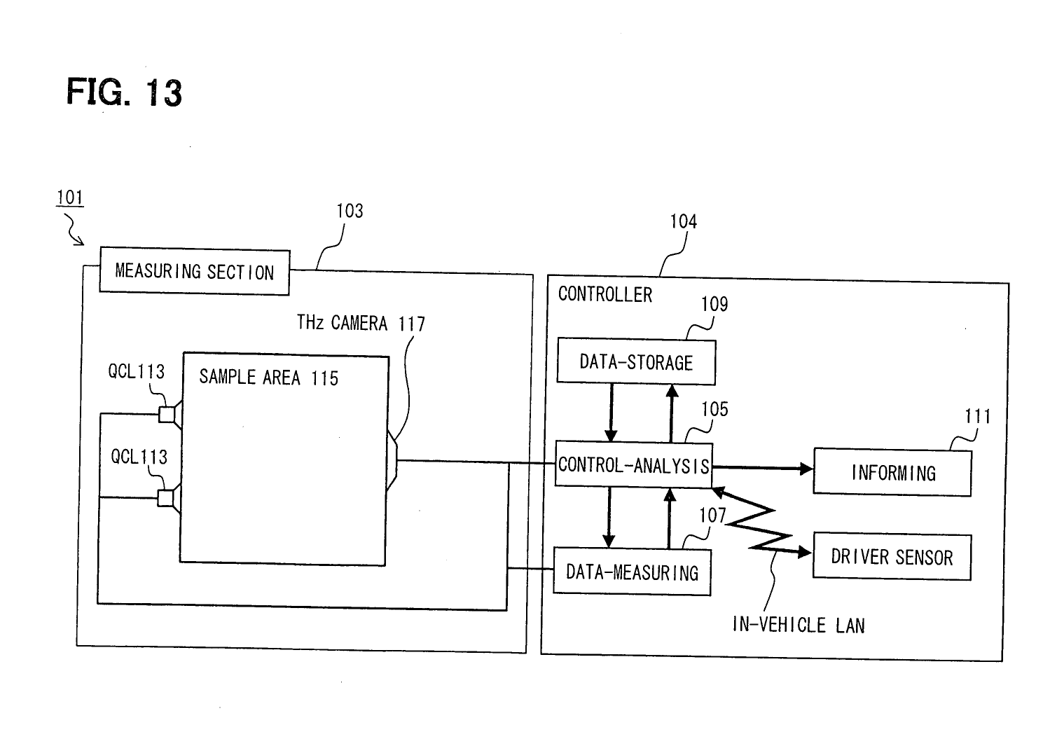

System of an absorption spectroscopy apparatus 101 according to the second embodiment is described while referring to FIG. 13.

An absorption spectroscopy apparatus 101 may be referred to as a gaseous sample analyzing apparatus which is an apparatus for measuring a concentration of alcohol in breath of a driver of a vehicle. An absorption spectroscopy apparatus 101 may be an in-vehicle apparatus. An absorption spectroscopy apparatus 101 includes a measuring section 103 and a controller 104. The controller 104 includes a control-analysis section 105, a data-measuring section 107, a data-storage section 109, and an informing section 111.

The measuring section 103 includes a plurality of QCLs (Quantum Cascade Laser) 113. Each one of the QCLs 113 is a laser generator which generates light having luminescence in a THz band, and which has a single frequency. A plurality of QCLs 113 generate and supply laser light which differ in frequency each other. The QCLs 113 are installed on the ceiling of the vehicle. The frequencies of the QCLs 113 are selected and adjusted to show relatively high or large level of the absorbance by ethanol, respectively. However, the frequencies of the QCLs 113 are selected and adjusted to show relatively low or small level of the absorbance by the background atmosphere. The absorbance by ethanol is distinguishably higher than the absorbance by the background atmosphere.

The measuring section 103 includes a THz camera 117 which can acquire a laser spectrum. The THz camera 117 is located on the sample area 115. The QCL 113 and the THz camera 117 are located and arranged on both end positions of the sample area 115. The THz camera 117 is located and arranged on an opposite side of the sample area 115 with respect to the QCL 113. The THz camera 117 is arranged to directly face the QCL 113. The sample area 115 may be an occupant room space in the vehicle to be measured. In detail, the THz camera 117 may be located and arranged on a console box part of the vehicle to face directly the QCL 113. As a result, the THz camera 117 receives terahertz radiation that is irradiated from the QCL 113 and travels through the sample area (occupant room space) 115. Alternatively, the apparatus 101 may include a bolometer instead of the THz camera 117.

The control-analysis section 105 controls luminescence operation of the QCL 113. The control-analysis section 105 submits command signal for acquiring signal of the THz camera 117 to the data measuring section 107, according to control signal for controlling the QCL 113. The control-analysis section 105 can be arranged in a console of the vehicle. The control-analysis section 105 also submits informing signal to the informing section 111, if final data of the analyzing processing (ethanol concentration) reaches to a numerical value that is equal to or larger than a predetermined constant value. In addition, the control-analysis section 105 performs processing mentioned later.

The data-measuring section 107 is installed close to the measuring section 103, and acquires signal of the THz camera 117. The data-measuring section 107 carries out an analog to digital conversion of the data from the THz camera 117, and submits digital data to the control-analysis section 105. The data-measuring section 107 also acquires desired data (mentioned later in detail) by comparing data by the data-measuring section 107 and the data-storage section 109.

The data-storage section 109 stores measurement data. Measurement data includes data when no driver exists, and data when a driver exists. The apparatus 101 may includes a driver sensor 113 for detecting a driver and determining whether a driver exists in a sample area. The data-storage section 109 also stores data for a database mentioned later.

The informing section 111 generates an information signal from an audio speaker (not illustrated) in the vehicle, when an informing signal is received from the control-analysis section 105.

(2) Processing

The apparatus 101 performs the following processing steps.

(i) Determining Driver's Existence

The apparatus 101 provides an occupant, i.e., a driver, detecting and determining module which detects a driver and determines whether a driver exists in the sample area. The controller 104 may includes the driver sensor 113 which provides an occupant detecting sensor for the occupant detecting module. The controller 104 performs the following processing (ii) when no driver is detected by the driver sensor 113. The controller 104 performs the following processing (iii) when a driver is detected by the driver sensor 113. The detection result of the driver sensor 113 may be submitted from the driver sensor 113 to the control-analysis section 105 via an in-vehicle LAN system. Determination of the existence of a driver, is performed repeatedly in a periodical manner.

(ii) Measurement of Background

The apparatus 101 provides a background measuring module which measures an intensity of transmitted terahertz radiation transmitted through the atmosphere when no driver exists. In the background measuring module, the THz camera 117 detects terahertz radiation which is radiated from the QCL 113 and passed through the sample area 115 to be measured. A terahertz radiation transmitted intensity through the background atmosphere will be obtained from the detection result. The terahertz radiation transmitted intensity through the background atmosphere is referred to as a terahertz radiation transmitted intensity A. As mentioned above, a plurality of QCLs 113 exist and each QCL 113 irradiates different frequency of terahertz radiation. Therefore, a plurality of terahertz radiation transmitted intensities A are obtained for a plurality of frequencies, respectively. The terahertz radiation transmitted intensities A obtained are stored in the data-storage section 109.

(iii) Measurement of Sample

The apparatus 101 provides a sample measuring module which measures an intensity of transmitted terahertz radiation transmitted through a gaseous sample when a driver exists. In the sample measuring module, the THz camera 117 detects the terahertz radiation which is radiated from the QCL 113 and passed through the sample area 115 to be measured. A terahertz radiation transmitted intensity through a gaseous sample when a driver exists in the sample area 115 will be obtained from the detection result. The terahertz radiation transmitted intensity through the gaseous sample when a driver exists in the sample area 115 is referred to as a terahertz radiation transmitted intensity B. As mentioned above, a plurality of QCLs 113 exist and each QCL 113 irradiates different frequency of terahertz radiation. Therefore, a plurality of terahertz radiation transmitted intensities A are obtained for a plurality of frequencies, respectively. The terahertz radiation Transmitted intensities B obtained are stored in the data-storage section 109.

(iv) Calculation of Concentration of Ethanol

The apparatus 101 provides a calculation module which calculates a concentration of target constituent, i.e., ethanol. In the calculation module, processing is performed when both the terahertz radiation transmitted intensity A in the processing (ii) and the terahertz radiation transmitted intensity B in the processing (iii) are obtained.

In each frequency, the terahertz radiation transmitted intensity A is subtracted from the terahertz radiation transmitted intensity B. By this processing, components obtained by influence of the background atmosphere are eliminated, and a terahertz radiation transmitted intensity obtained only by ethanol is calculated. The terahertz-radiation-transmitted intensity obtained only by ethanol is referred to as a terahertz radiation transmitted intensity C. Therefore, a plurality of terahertz radiation transmitted intensities C are calculated for a plurality of frequencies, respectively. The terahertz radiation transmitted intensities C obtained are stored in the data-storage section 109.

The data storage section 109 stores a database that defines a concordance among the terahertz radiation transmitted intensities C, an output signal of the QCL 113, and a concentration of ethanol in the gaseous sample in each one of frequencies. Therefore, it is possible to calculate an ethanol concentration by looking up the database based on the terahertz radiation transmitted intensity C and the output signal of the QCL 113.

(v) Informing Processing

The apparatus 101 provides an informing module which informs the results of the above-mentioned measuring process to a user of the apparatus 101 by using such as a user interface device. If the ethanol concentration detected by the above-mentioned processing (iv) is higher than a predetermined threshold value, the control-analysis section 105 submits the informing signal to the informing section 111. The informing section 111 informs a result of detecting processing of ethanol according to the informing signal. For example, the informing section 111 generates a warning signal when an ethanol concentration is equal to or higher than a certain level.

(3) Advantages

The absorption spectroscopy apparatus 101 calculates an ethanol concentration by using frequency components that shows relatively low absorbance by the background atmosphere in the frequency range of terahertz which is radiated from the THz emitter.

Since the frequency is distributed comparatively broadly, terahertz radiating means, i.e., the QCL 113, for irradiating a sample with terahertz radiation is not required to provide high level of frequency discrimination resolution. As a result, it is possible to reduce manufacturing cost of the absorption spectroscopy apparatus 101.

It is apparent that the present invention shall not be interpreted narrowly based on the above-mentioned embodiment, and shall be possible to apply to various embodiments within a scope of the present invention.

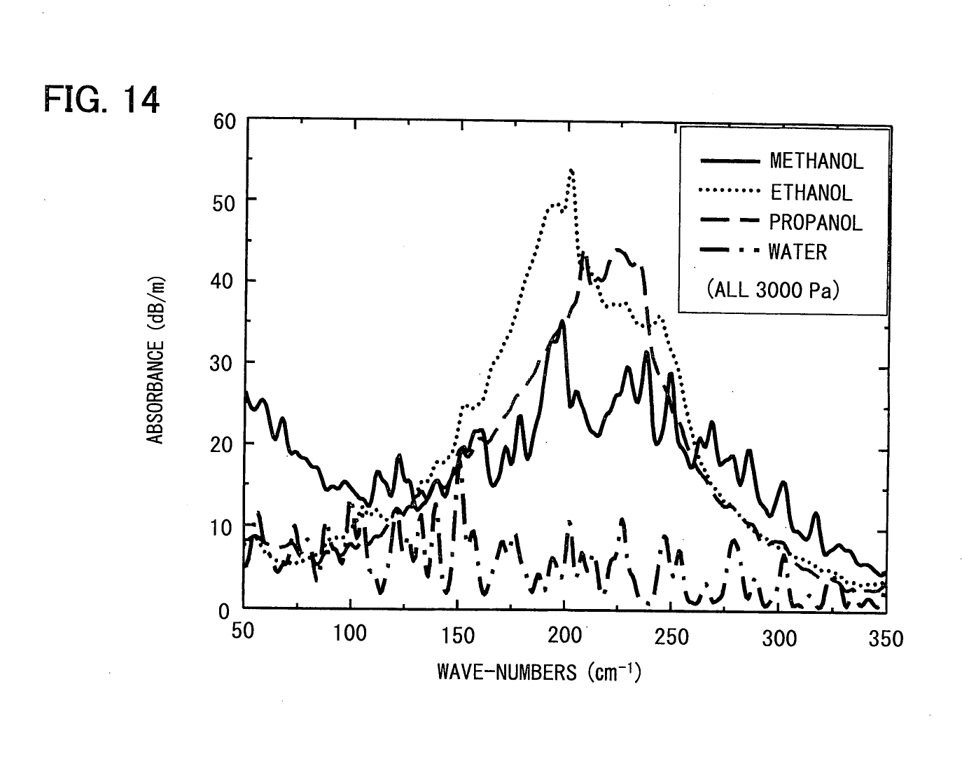

Wide variety of substances that shows broad absorption characteristic in a frequency range of terahertz radiation can be used as the specific constituent to be measured by the apparatus. For example, the specific constituent may be component of alcohol, e.g., methanol, and propanol, or water. FIG. 14 shows absorption characteristics of methanol, ethanol, propanol, and water in the frequency range of terahertz radiation. Methanol, propanol, and water also have broadly distributed absorption characteristic in the frequency range of terahertz radiation. Therefore, like the case of ethanol, concentration of methanol, propanol, and water can be measured by the apparatus and methods described in the embodiments.

In the first embodiment, the absorption spectroscopy apparatus 1 measures an absorbance β (BETA) of the background atmosphere in each measuring event. However, the absorbance β (BETA) of the background atmosphere may be measured beforehand and stored in the apparatus as a fixed value.

In the second embodiment, the absorption spectroscopy apparatus 101 measures the terahertz radiation transmitted intensity A in each measuring event. However, the terahertz radiation transmitted intensity A may be measured beforehand and stored in the apparatus as a fixed value.

In the first embodiment, the data-storage section 9 may store a data table instead of the database. The data table may define a relation between absorbance a (ALPHA) and ethanol concentration, respectively. The apparatus 1 may be arranged to look up the data table based on the calculated absorbance α (ALPHA), and to perform a complement calculation to calculate an ethanol concentration.

In the second embodiment, the data-storage section 109 may store a data table instead of the database. The data table may define a relation between terahertz radiation transmitted intensity B and ethanol concentration, respectively. The apparatus 101 may be arranged to look up the data table based on the calculated terahertz radiation transmitted intensity B, and to perform a complement calculation to calculate an ethanol concentration.

Although the present invention has been fully described in connection with the preferred embodiments thereof with reference to the accompanying drawings, it is to be noted that various changes and modifications will become apparent to those skilled in the art. Such changes and modifications are to be understood as being within the scope of the present invention as defined by the appended claims.

What is claimed is:

1. An apparatus of absorption spectroscopy for gaseous samples, comprising
a measuring section which acquires an absorbance by a gaseous sample by irradiating the gaseous sample with terahertz radiation; and
an analysis section which calculates the concentration of the specific constituent in the gaseous sample based on the absorbance.

2. The apparatus of absorption spectroscopy for gaseous samples in claim 1, wherein
terahertz radiation contains a range of frequency where the specific constituent shows an absorbance that is larger than an absorbance by a background constituent contained in the gaseous sample, and where a spectrum of absorbance by the background constituent shows relatively flat profile.

3. The apparatus of absorption spectroscopy for gaseous samples in claim 2, further comprising:
background absorption spectral acquiring means for acquiring a spectral of absorbance by the background constituent in a range of terahertz; and
frequency setting means for setting a frequency of terahertz radiation used in the measuring section based on the spectral of absorbance by the background constituent.

4. The apparatus of absorption spectroscopy for gaseous samples in claim 1, wherein
a frequency band of terahertz radiation used in the calculation of the concentration of the specific constituent is equal to or less than ±3 cm⁻¹.

5. The apparatus of absorption spectroscopy for gaseous samples in claim 1, wherein
the measuring section acquires absorbance in a plurality of frequencies, respectively; and
the analysis section identifies the kind of the specific constituent based on a pattern of absorbance in the plurality of frequencies.

6. The apparatus of absorption spectroscopy for gaseous samples in claim 1, wherein
the specific constituent includes a component of alcohol.

7. The apparatus of absorption spectroscopy for gaseous samples in claim 1, wherein
the measuring section includes:
first acquiring means for acquiring absorbance of terahertz radiation by the gaseous sample which is expected to include the specific constituent; and
second acquiring means for acquiring absorbance of terahertz radiation by the background constituent which is an unavoidable constituent in the gaseous sample, and wherein
the analysis section calculates the concentration of the specific constituent in the gaseous sample based on a difference between the absorbance by the gaseous sample in a predetermined frequency which shows relatively low absorbance by the background constituent and the absorbance by the background constituent in the predetermined frequency.

8. The apparatus of absorption spectroscopy for gaseous samples in claim 7, wherein
the analysis section uses a plurality of predetermined frequencies which show relatively low absorbance by the background constituent, and wherein
the analysis section calculates the concentration of the specific constituent based on the differences in the plurality of predetermined frequencies.

9. The apparatus of absorption spectroscopy for gaseous samples in claim 8, wherein
the analysis section includes detecting means for detecting absorbance in the determined frequency from absorbance measured by the measuring section.

10. The apparatus of absorption spectroscopy for gaseous samples in claim 8, wherein
the measuring section irradiates terahertz radiation consists of the determined frequency.

11. The apparatus of absorption spectroscopy for gaseous samples in claim 8, wherein
the measuring section measures the gaseous sample in a room of a vehicle, and wherein
the second acquiring means measures the absorbance by the background constituent when no driver exists.

12. The apparatus of absorption spectroscopy for gaseous samples in claim 1 wherein
the absorbance is shown by terahertz radiation transmitted intensity.
